(19) United States
(12) Patent Application Publication
(10) Pub. No.: US 2009/0066202 A1
(43) Pub. Date: Mar. 12, 2009

(54) HANGING FILE FOLDER RETAINING DEVICE

(75) Inventor: Donald Meltzer, Aurora, CO (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: AMERICAN PAD & PAPER LLC, Richardson, TX (US)

(21) Appl. No.: 12/237,206

(22) Filed: Sep. 24, 2008

Related U.S. Application Data
(63) Continuation-in-part of application No. 11/453,171, filed on Jun. 13, 2006.

(51) Int. Cl. B42F 15/00

(52) U.S. Cl. 312/184

(57) ABSTRACT

An exemplary hanging file folder retainer is provided that, in one embodiment, includes a first attaching member, a second attaching member, and a retaining member. The first and second attaching members couple to a hanging file drawer rail in order to secure the hanging file folder retainer to the hanging file drawer rail. The second attaching member is linearly disposed from the first attaching member such that the hanging file folder retainer is secured to the hanging file drawer rail in at least two locations. The retaining member has a length sufficient to at least span the distance between said first and second attaching members. The retaining member can also be increased or decreased upon installation along the hanging file drawer rail depending on the length of the hanging file drawer rail. In at least one functional position, the retaining member inhibits hanging file tabs from disengaging from the hanging file drawer rail.

### CROSS-REFERENCE TO RELATED APPLICATION

This application is a continuation-in-part of U.S. application Ser. No. 11/453,171 filed Jun. 13, 2006, now pending, and is incorporated herein by reference in its entirety.

### BACKGROUND OF THE INVENTION

My prior application Ser. No. 11/453,171, discloses, for example, a hanging file folder retainer in which hanging file folders are inhibited from falling off of the guide rail of a file drawer yet which enables access to the file folders allowing their removal from and insertion into the filing drawer as needed. The hanging file folder retainer apparatus described and claimed in my prior application is particularly advantageous as, among other things, it employs attaching members for securing the hanging file folder retainer to a hanging file drawer rail and also employs a retaining member having a length sufficient to at least span the distance between the attaching members such that, in at least one functional position, the retaining member inhibits hanging file tabs from disengaging from the hanging file drawer rail.

There has been a continuing need for improvements in such hanging file folder retainers, including improvements in the way users are able to access hanging files stored in the file drawer as well as the way hanging file folder retainers are secured to hanging file drawer rails. There has also been a need for improvements in hanging file folder retainers to ensure that hanging file folders are inhibited from disengaging the hanging file drawer rail.

### SUMMARY OF THE INVENTION

The present invention provides an improved hanging file folder retainer apparatus.

According to one aspect of the invention, a hanging file folder retainer is provided that includes, in one embodiment, a first attaching member, a second attaching member, and a retaining member. The first and second attaching members couple to a hanging file drawer rail in order to secure the hanging file folder retainer to the hanging file drawer rail. The second attaching member is linearly disposed from the first attaching member such that the hanging file folder retainer is secured to the hanging file drawer rail in at least two locations. The retaining member has a length sufficient to at least span the distance between said first and second attaching members. The retaining member can also be increased or decreased upon installation along the hanging file drawer rail depending on the length of the hanging file drawer rail. In at least one functional position, the retaining member inhibits hanging file tabs from disengaging from the hanging file drawer rail.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is an exemplary hanging file cabinet in which the present invention may be implemented;

FIG. 2 is an exemplary file drawer for hanging file folders in which a hanging file folder retainer may be implemented in accordance with one embodiment of the present invention;

FIG. 3 is a more detailed view of an exemplary file drawer rail and an exemplary hanging file retainer in accordance with one embodiment of the present invention;

FIGS. 4A-4J show various views of an exemplary hanging file retainer and pivoting retaining member in accordance with one embodiment of the present invention;

FIGS. 5A-5C show various views of an exemplary hanging file retainer and pivoting retainer member in accordance with one embodiment of the present invention;

FIGS. 6A-6J show various views of an exemplary hanging file retainer with dual axis points and magnets for securing the hanging file retainer to a file drawer rail and a pivoting retaining member with a molded pin lock for securing the retaining member closed in accordance with one embodiment of the present invention;

FIGS. 7A-7M show various views of an exemplary hanging file retainer with clamps for securing the hanging file retainer to a file drawer rail and a pivoting retaining member with a snap lid for securing the retaining member closed in accordance with one embodiment of the present invention;

FIGS. 8A-8O show various views of an exemplary hanging file retainer with clips for securing the hanging file retainer to a file drawer rail and a telescoping retaining member in accordance with one embodiment of the present invention;

FIGS. 9A-9G show various views of an exemplary clip for use with hanging file retainers in accordance with one embodiment of the present invention; and

FIGS. 10A-10G show various views of an exemplary one-piece hanging file retainer in accordance with one embodiment of the present invention.

### DETAILED DESCRIPTION OF THE INVENTION

It should be understood at the outset that although an exemplary implementation of the present invention is illustrated below, the present invention may be implemented using any number of techniques, whether currently known or in existence. The present invention should in no way be limited to the exemplary implementations, drawings, and techniques illustrated below, including the exemplary design and implementation illustrated and described herein. Like reference numerals refer to like elements throughout the description. Additionally, the drawings contained herein are not necessarily drawn to scale.

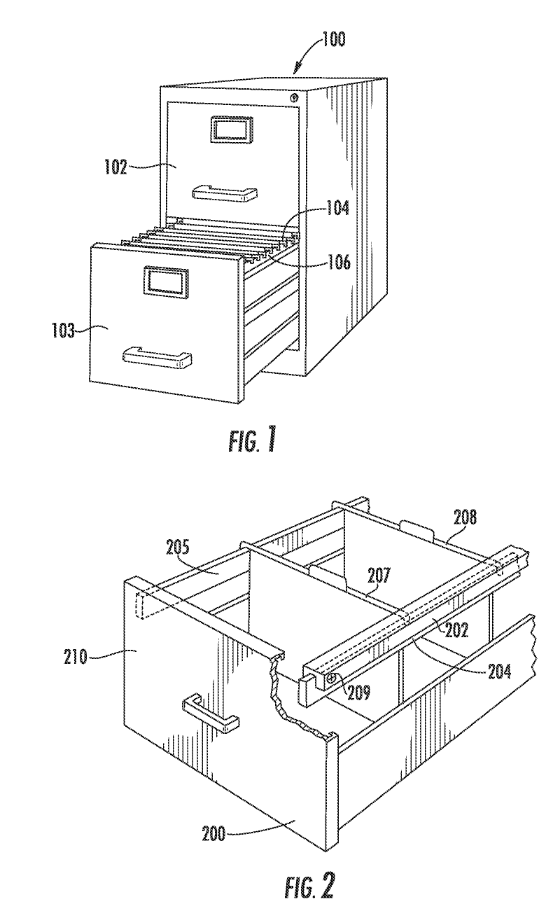

With reference now to the figures, and in particular with reference to FIG. 1, an exemplary hanging file cabinet is shown in which the present invention may be implemented. File cabinet 100 includes two file drawers 102-103. Guide rails 106 are provided within the file drawers 102-103 in which to hang hanging file folders 104.

File cabinet 100 is presented merely as an example of a file cabinet. Those skilled in the art will recognize that the present invention may be utilized with many different types of file cabinets including, for example, those with more or fewer file drawers as well as lateral file cabinets. As such, the present invention is not limited to use with any one type of file cabinet.

With reference now to FIG. 2, an exemplary file drawer for hanging file folders in which a hanging file folder retainer may be implemented in accordance with one embodiment of the present invention is shown. File drawer 200 is an example of a file drawer that may be implemented as, for example, any of file drawers 102-103 depicted in FIG. 1. File drawer 200 includes file drawer rails 204-205 on which the tab portion of hanging file folders 207-208 may rest thereby allowing the hanging file folders 207-208 to hang in the file drawer 200.

A hanging file retainer 202 is attached to file drawer rail 204 thereby inhibiting or preventing the tabs for hanging file folders 207-208 from disengaging from the file drawer rail 204. In the depicted example, the hanging file retainer 202 fits over the file drawer rail 204 as indicated and is locked into place over the file drawer rail 204 by a locking screw 209 thereby preventing the hanging file retainer 202 from being accidentally knocked off of the file drawer rail 204. If a hanging file folder 207-208 needs to be removed or replaced or if a new hanging file folder needs to be inserted into file drawer 200, the hanging file retainer may be removed by unscrewing the lock screw 209 and removing the hanging file retainer 202. Although not depicted in FIG. 2, a hanging file retainer, such as, for example, hanging file retainer 202, may be attached to file drawer rail 205 as well.

Although not depicted, the hanging file retainer 202 typically also includes an attaching and locking mechanism at the opposite end from screw 209 which, in the depicted example, would be located in the file drawer 200 in a spot farther from the front 210 of the file drawer 200 than screw 209. It should be noted that hanging file retainer 202 depicted in FIG. 2 is but one example of a hanging file retainer 202 that may be utilized to prevent or inhibit disengagement of hanging file folder tabs from a file drawer rail and is provided merely in order to illustrate one method of how a hanging file retainer may fit over a file drawer rail and prevent or inhibit disengagement of the hanging file folder tabs form the file drawer rail. Many other embodiments are possible, some of which are described below in order to better explain and illustrate the hanging file retainer of the present invention.

With reference now to FIG. 3, a more detailed view of an exemplary file drawer rail and an exemplary hanging file retainer is shown in accordance with one embodiment of the present invention. File drawer rail 301 is an example of a file drawer rail for use in a file cabinet, such as, for example, file drawer rail 204 in file drawer 200 depicted in FIG. 2. File drawer rail 301 is configured such that a hanger 315 of a hanging file folder 308 may rest on the file drawer rail 301 with the tab 310 extending down over the outside of the file drawer rail 301 such that the hanging file folder 308 may hang within a file drawer from the file drawer rail 301 as depicted in FIG. 3.

A hanging file retainer 300 may be placed over file drawer rail 301 such that the tab 310 is constrained to remain resting over the outside of the file drawer rail 301 thereby inhibiting or preventing the hanging file folder 308 from being removed from the file drawer or from dropping off of the file drawer rail 301 and becoming lost in the bottom of the file drawer.

Hanging file retainer 300 includes two attaching members 304 and 305 by which the hanging file retainer 300 is attached to the file drawer rail 301. Hanging file retainer 300 also includes a linking member 303 and a pivoting retaining member 302 that spans the distance between attaching members 304-305 and is configured that in a locked position, the retaining member 302 is situated sufficiently close to the file drawer rail 301 such that the hanging file folder 308 may not be raised sufficiently that the tab 310 can move away from the outside part of the file drawer rail 301. Linking member 303 connects attaching member 304 to attaching member 305. In many embodiments, attaching members 304-305, linking member 303 and retaining member 302 are fabricated from semi-rigid thermoplastic. However, many other materials may be used as well as those skilled in the art will recognize.

Typically, the distance between the file drawer rail 301 and retaining member 302 is sufficient that movement of the hanger 315 back and forth along the file drawer rail 301 is not significantly impeded, but is less than the distance that the tab 310 extends down over the file drawer rail 301 so that in no instance may the hanging file folder 308 be removed from or fall off of the file drawer rail 301.

In the depicted example, the hanging file retainer 300 is secured to the file drawer rail 301 by turning locking screws 306-307 sufficiently to secure the attaching members 304-305 to the file drawer rail 301 once the hanging file retainer's 300 attaching members 304-305 have been placed over the file drawer rail 301. The attaching members 304-305, in many embodiments, are generally three sided such that they surround three sides of the file drawer rail 301. In one embodiment, the cross-section of the attaching members is “U” shaped. In one embodiment, one downwardly extending portion of the attaching members 304-305 also includes an extension, which when attaching members 304-305 is secured to the file drawer rail, the extension snaps in place on the underside of the file drawer rail such that at least a portion of attaching members 304-305 is in contact with each side of the file drawer rail. Also as depicted in FIG. 3, the retaining member 302 may pivot about a pivot axis 312 to an open position allowing file folders to be removed or added. In the closed position, the retaining member 302 locks into place to secure the hanging file folders 308. Those skilled in the art will recognize that various mechanisms may be utilized to lock the retaining member 302 into a closed position.

Hanging file retainer 300 is presented as an example of one embodiment of a hanging file retainer and is not meant to imply any architectural limitations to the present invention. Those skilled in the art will recognize many modifications and variations that may be applied to the depicted hanging file retainer 300 without from the scope and spirit of the present invention. For example, other embodiments may include a retaining member that does not pivot and may include other means for securing the hanging file retainer 300 to the file drawer rail 301 rather than the screws 306-307 depicted in FIG. 3. Examples of several embodiments for a hanging file retainer are described below.

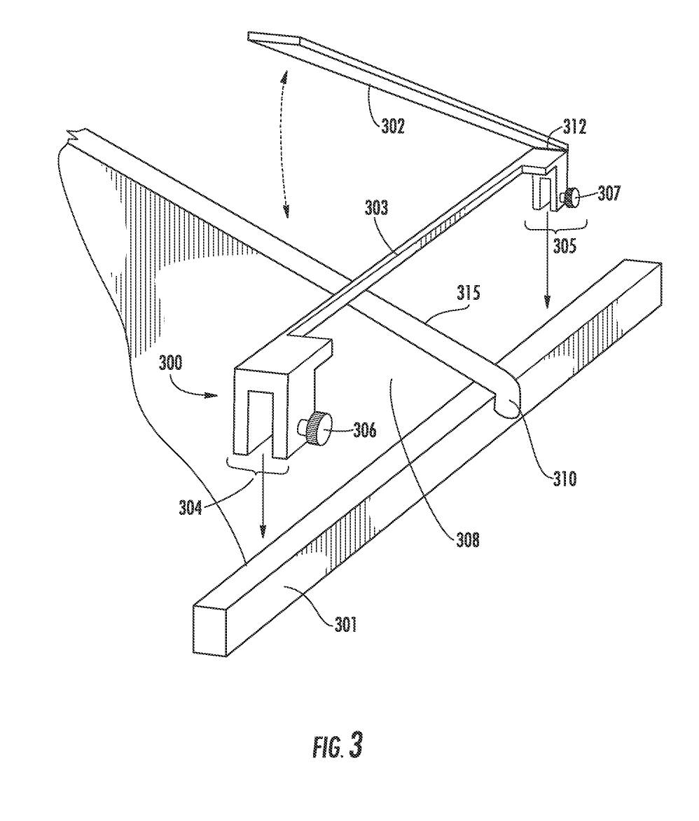

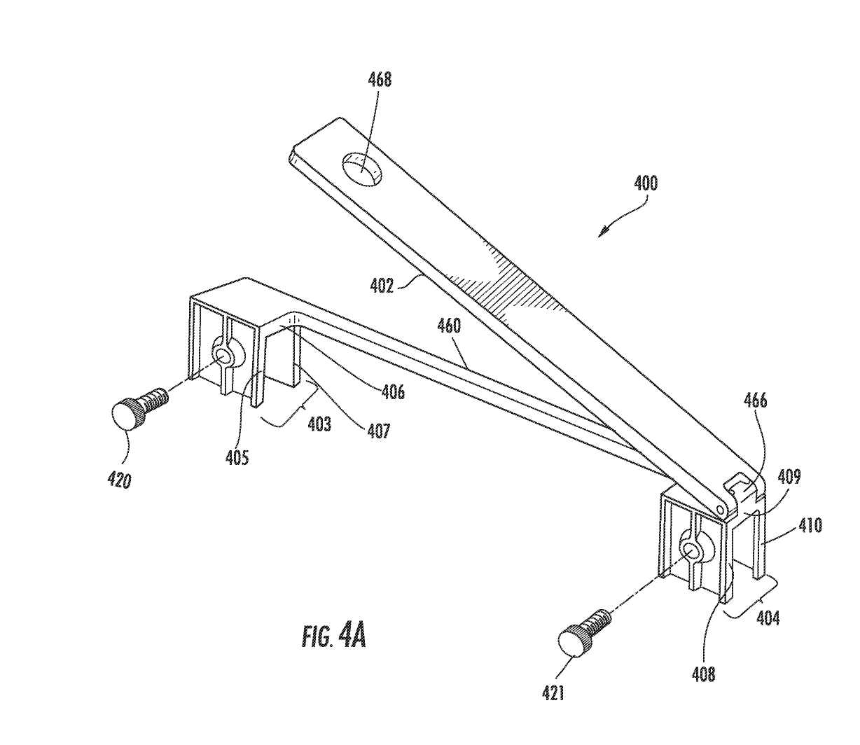

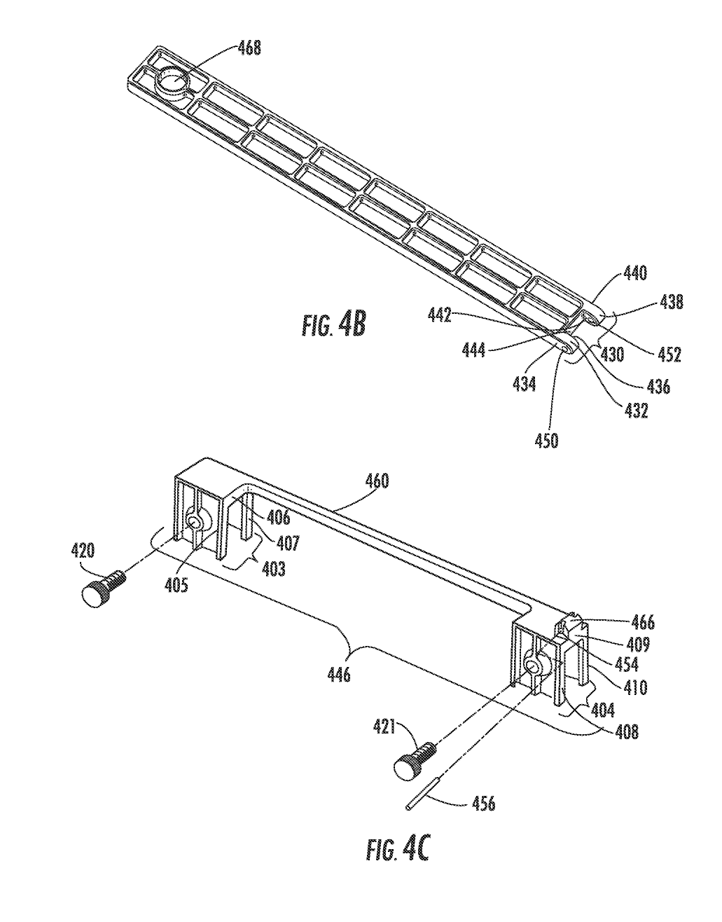

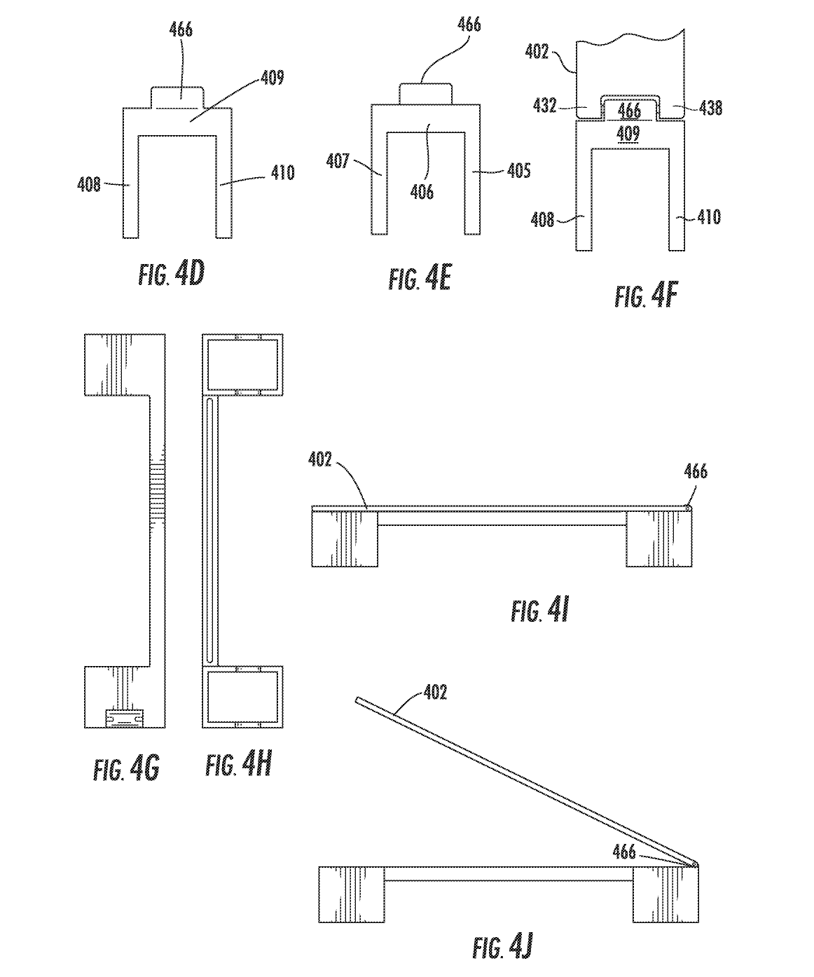

With reference now to FIGS. 4A-J, various views of an exemplary hanging file retainer are shown in accordance with one embodiment of the present invention. FIG. 4A provides a perspective view of an exemplary hanging file retainer 400 in accordance with one embodiment of the present invention. FIG. 4B provides a perspective view of an exemplary pivoting retaining member 402 in accordance with one embodiment of the present invention. FIG. 4C provides a perspective view of an exemplary hanging file retainer base 446 of the hanging file retainer 400 in accordance with one embodiment of the present invention. FIG. 4D shows the hinged end of hanging file retainer 400 in a closed position in accordance with one embodiment of the present invention. FIG. 4E shows the front end of the hanging file retainer 400 in a closed position in accordance with one embodiment of the present invention. FIG. 4F shows the hinged end of hanging file retainer 400 in an open position in accordance with one embodiment of the present invention. FIGS. 4G and 4H show top and bottom views respectively of hanging file retainer 400 in accordance with one embodiment of the present invention. FIGS. 4I and 4J show side closed and side open views of hanging file retainer 400 in accordance with one embodiment of the present invention.

Referring now to FIGS. 4A and 4C, hanging file retainer 400 comprises a continuous material and includes two attaching members 403-404, a linking member 460, and a pivoting retaining member 402. The length of the retaining member 402 varies depending on implementation. Of course, for any particular implementation, the length may not be longer than the depth of the file drawer. Lengths that are shorter than the length of the file drawer rail are possible in some implementations. Typical lengths of hanging file retainer apparatus of the present invention are about 8-12 inches, and for larger implementations (such as for example, lateral file drawers) are about 3 feet in length. The height of hanging file retainer apparatus of the present invention generally range from about 0.75 inches to 1.5 inches, but may be larger or smaller depending on the implementation. The width of hanging file retainer apparatus of the present invention generally range from about 0.75 inches to 1.5 inches, but may be larger or smaller depending on the implementation.

Also, in some embodiments, retaining member 402 may extend past one or both of attaching members 403 and 404. Hanging file retainer 400, in one embodiment, includes locking screws 420 and 421 which may be tightened once the hanging file retainer 400 has been appropriately located thereby securing hanging file retainer 400 to a file drawer rail. Linking member 460 connects attaching member 403 to attaching member 404.

Each attaching member 403-404 includes a first vertical attaching member 405 or 408, a second vertical attaching member 407 or 410, and a top attaching member 406 or 409. Each attaching member 403-404 is secured to a file drawer rail, such as, for example, file drawer rail 301 depicted in FIG. 3. The attaching member 403-404 are sufficiently flexible such that the first attaching member 405 or 408 may be moved away from the second vertical attaching member 407 or 409 such that the attaching member 403-404 may slip over the file drawer rail, which may vary in size and thickness. In accordance with the present invention, attaching members 403-404 are generally at a 90 degree angle with respect to the file drawer rail.

Referring in particular to FIG. 4A, pivoting retaining member 402 pivots about a pivot axis 466 between open and closed positions. As shown in FIG. 4B, pivoting retaining member 402 contains a U-shaped notch 430 defined by a first hinge member 432 having an outer edge 434 and an inner edge 436, a second hinge member 438 having an outer edge 440 and an inner edge 442, and a center inner edge 444, such center inner edge 444 connecting the inner edges 436, 442 of the first hinge member 432 and second hinge member 438, respectively. The U-shaped notch 430 of pivoting retaining member 402 is configured to slide down over pivot axis 466 (see FIG. 4C) of the hanging file retainer base 446 in the final assembly. First hinge member 432 and second hinge member 438 each contain apertures 450, 452 forming a cavity that passes through the entirety of first hinge member 432 and second hinge member 438. Similarly, pivot axis 466 contains an aperture 454 which passes through the entirely of pivot axis 466. When U-shaped notch 430 of pivoting member 402 is secured to pivot axis 466, the respective apertures 450, 452, 454 line up to enable a pin 456 to be inserted through the entire created cavity in order to secure the pivoting retaining member 402 to the hanging file retainer base 446.

As shown in FIGS. 4A and 4B, pivoting retaining member 402 also provides an enlarged opening 468 on the top surface of pivoting retaining member 402 as illustrated. Opening 468 is useful in allowing users to grasp pivoting retaining member 402 in order to raise or lower pivoting retaining member 402 as desired. It will be understood that pivoting retaining member 402 may employ a variety of openings and fixtures, including handles and knobs, to assist the user in moving pivoting retaining member 402 to its open and closed positions.

When pivoting retaining member 402 is in the closed position, and the hanging file retainer 400 is secured to a file drawer rail, hanging file folders are restricted to hanging from the file drawer rail and are prevented or inhibited from falling from the rail or being removed from the rail. When the pivoting retaining member 402 is in the open position, hanging file folders may be removed from or added into the file drawer. Linking member 460 is located on the opposite side of the file drawer rail from the location of the hanging file folders. Thus, linking member 460 is positioned such that it does not interfere with movement of the hanging file folders along the file drawer and does not hinder removal or placement of hanging files within the file drawer.

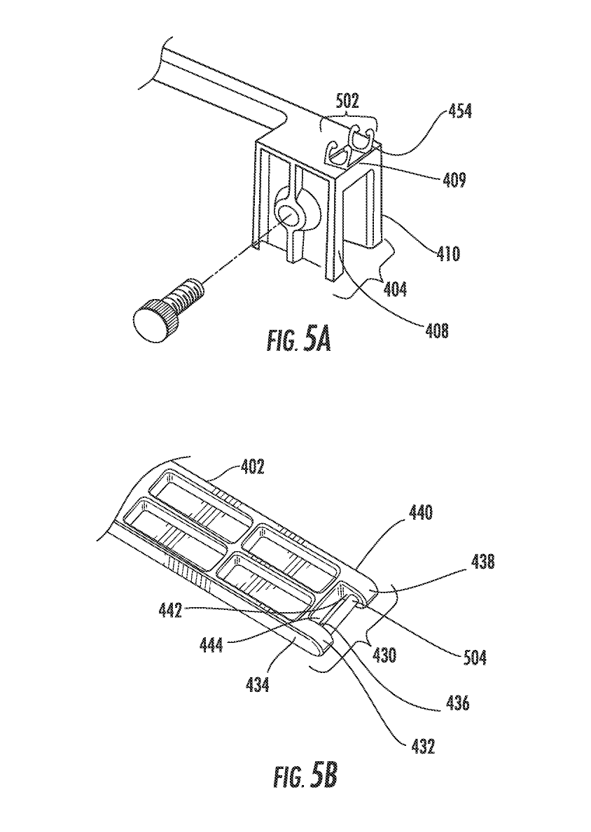

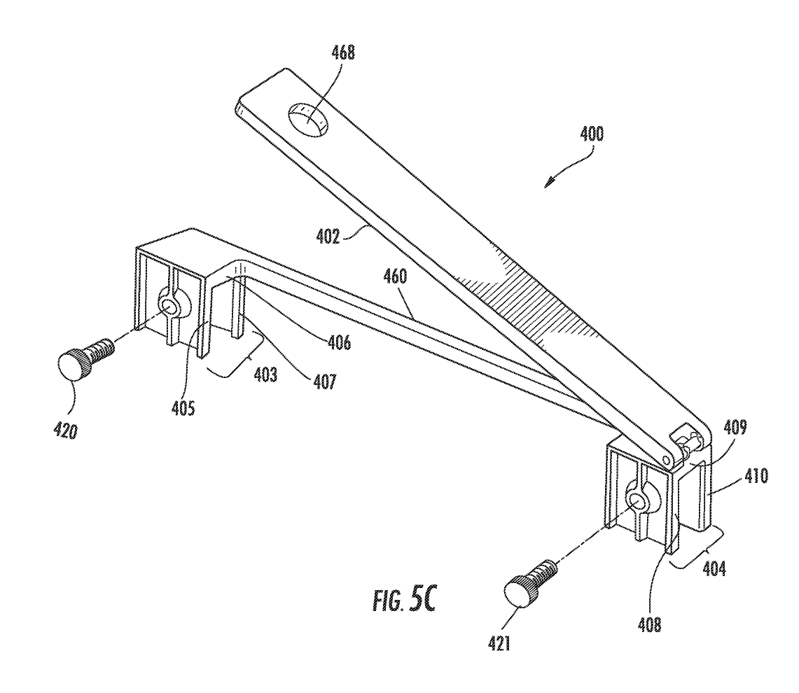

In certain embodiments of the hanging file retainer apparatus, it may be desired to modify the attachment of the pivoting retaining member 402 to the hanging file retainer base 446 at pivot axis 466 as illustrated in FIGS. 4A-4C. Turning now to FIGS. 5A and 5B, hanging file retainer base 446 may be modified by providing an alternative pivot axis in the form of an open “u” clip 502 suitably connected to hanging file retainer base 446. Likewise, as shown in FIG. 5B, pivoting retaining member 402 may be modified such that instead of providing a U-shaped notch 430 with apertures 450, 452 as shown in FIG. 4A, the U-shaped notch 430 includes a bar member 504, wherein one end of the bar member 504 is suitably connected to the inner edge 436 of the first hinge member 432 and the other end of the bar member 504 is connected to the inner edge 442 of the second hinge member 438. When assembled, bar member 504 of pivoting member 402 may be snapped into the open “u” clip 502 as shown in FIG. 5C.

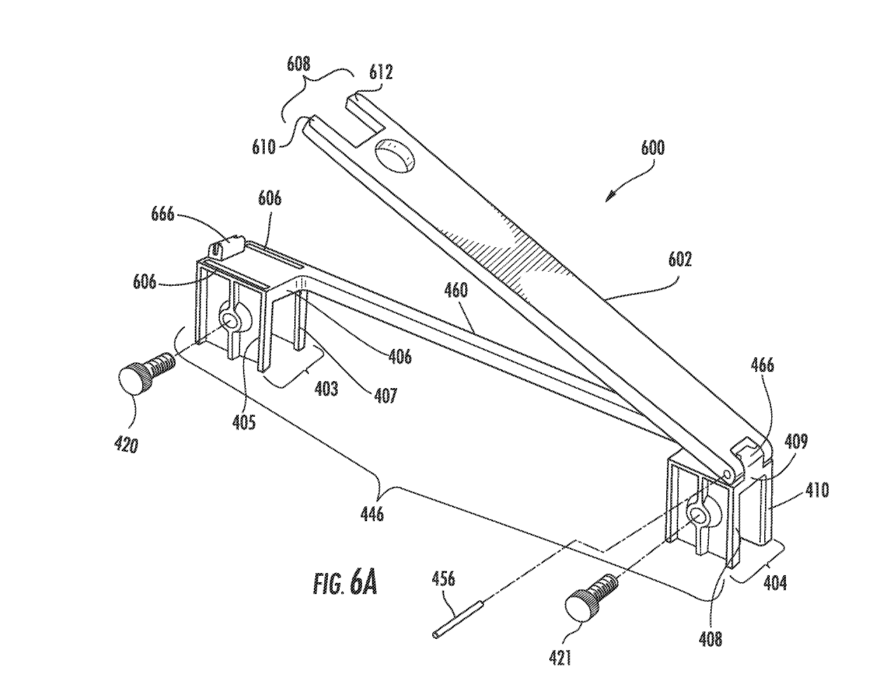

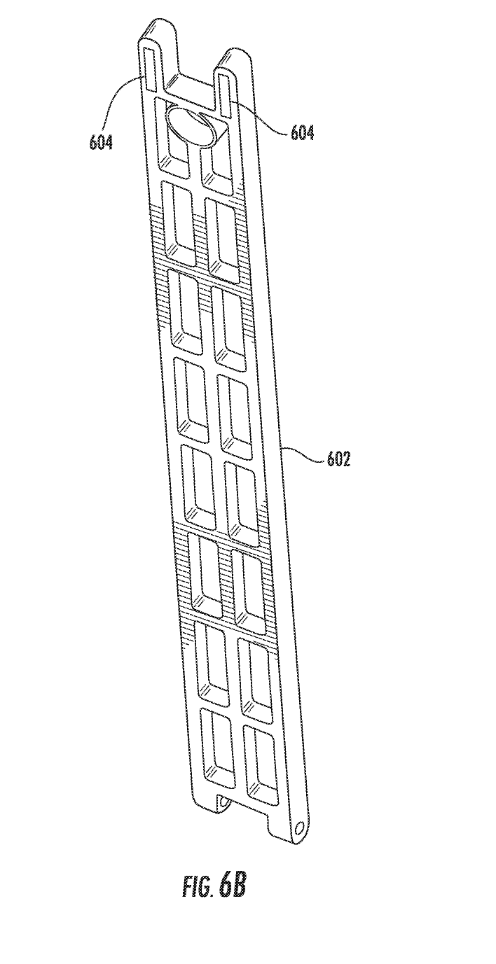

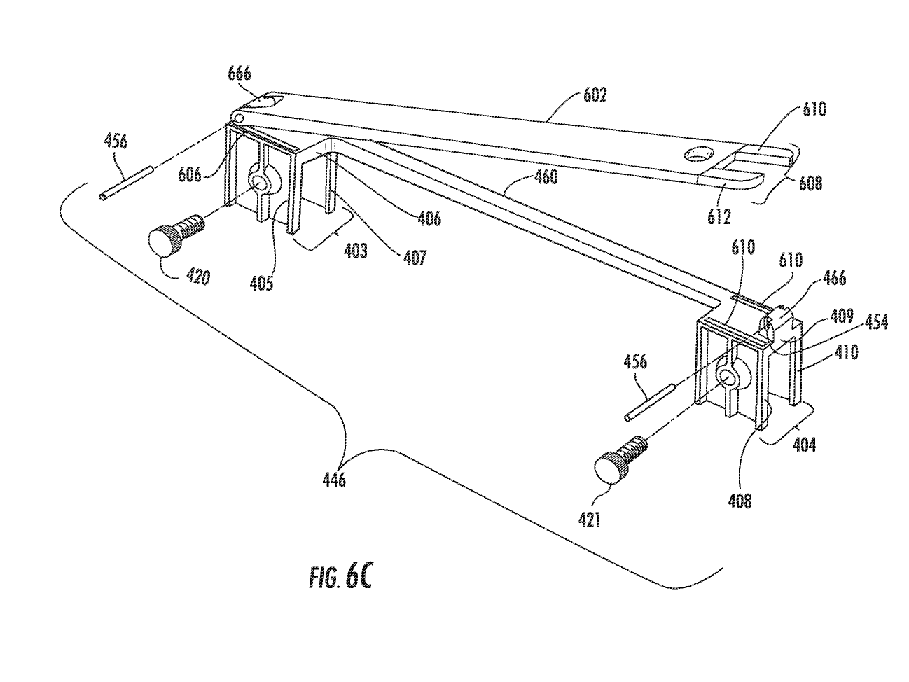

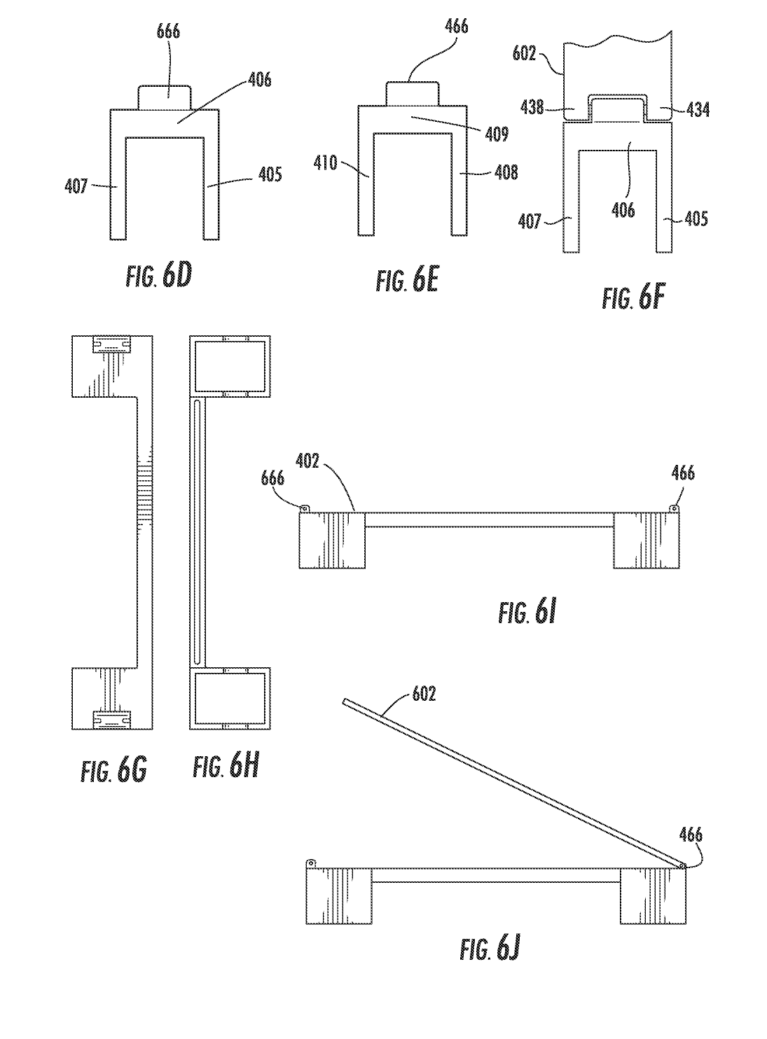

Referring now to FIGS. 6A-6J, various views of an exemplary hanging file retainer employing magnets for securing the retaining member closed are shown in accordance with one embodiment of the present invention. FIG. 6A shows a perspective view of hanging file retainer 600 in accordance with one embodiment of the present invention. FIG. 6B shows a perspective view of retaining member 602 in accordance with one embodiment of the present invention. FIG. 6C shows a perspective view of hanging file retainer base 446 with dual axis points 466, 666 and retaining member 602 in accordance with one embodiment of the present invention. FIG. 6D shows the hinged end of hanging file retainer 600 in accordance with one embodiment of the present invention. FIG. 6E shows the lock end of the hanging file retainer 600 in accordance with one embodiment of the present invention. FIG. 6F shows the hinged end of hanging file retainer 600 in an open position in accordance with one embodiment of the present invention. FIGS. 6G and 6H show top and bottom views respectively of hanging file retainer 600 in accordance with one embodiment of the present invention. FIGS. 6I and 6J show side closed and side open views of hanging file retainer 600 in accordance with one embodiment of the present invention.

Hanging file retainer 600 is similar in many respects to hanging file retainer 400 depicted in FIG. 4, except for the mechanism for locking the pivoting retaining member 602 closed, as well as an additional pivot axis member 666 secured to the top size of attaching member 403 as illustrated in FIG. 6A. Hanging file retainer 600 comprises a continuous material and includes two attaching members 403-404, a pivoting retaining member 602, and a linking member 460. In this embodiment, magnets 604, or other suitable connection means, are attached to the underside of pivoting retaining member 602 (see FIG. 6B) and may be attached to complimentary strips of metal 606 on the top side of attaching member 603 (see FIG. 6C) as illustrated thereby securing the hanging file retainer 600 in a closed position preventing removal of hanging file folders.

Still referring to FIG. 6A, hanging file retainer base 446 contains an additional pivot axis 666 secured to the top side of attaching member 403 as illustrated. Pivot axis 666 is configured the same as pivot axis 466. As will be appreciated, the inclusion of dual pivot axes 446 and 666 allow the user to alternate the location in which pivoting retaining member 602 is attached to hanging file retainer base 446. As an example, the user may desire for pivoting retainer member 602 to be attached at pivot axis 466 as illustrated in FIG. 6A. Or alternatively, the user may desire for pivoting retainer member 602 to be attached at pivot axis 666 as illustrated in FIG. 6C. Such versatility in the attachment of pivoting retaining member 602 is useful in that the user can decide which configuration bests suits his/her needs depending on the configuration of the file drawer(s) in relation to other elements of the office set up.

Still referring to FIGS. 6A and 6B, locking end 608 of pivoting retaining member 602 is configured in a “u shape” configuration as illustrated, defined by a first clasp member 610 and a second clasp member 612. When retaining member 602 is in the closed position (secured by magnetism created by magnets 604 (FIG. 6B) and strips of metal 606), first clasp member 610 and second clasp member 612 are located on either side of second pivot axis member 666. Similarly, as shown in FIG. 6C, when pivoting retaining member 602 is alternatively attached at second pivot axis member 666, and when retaining member 602 is in the closed position (secured by magnetism created by magnets 604 and strips of metal 610), first clasp member 610 and second clasp member 612 are located on either side of pivot axis member 466.

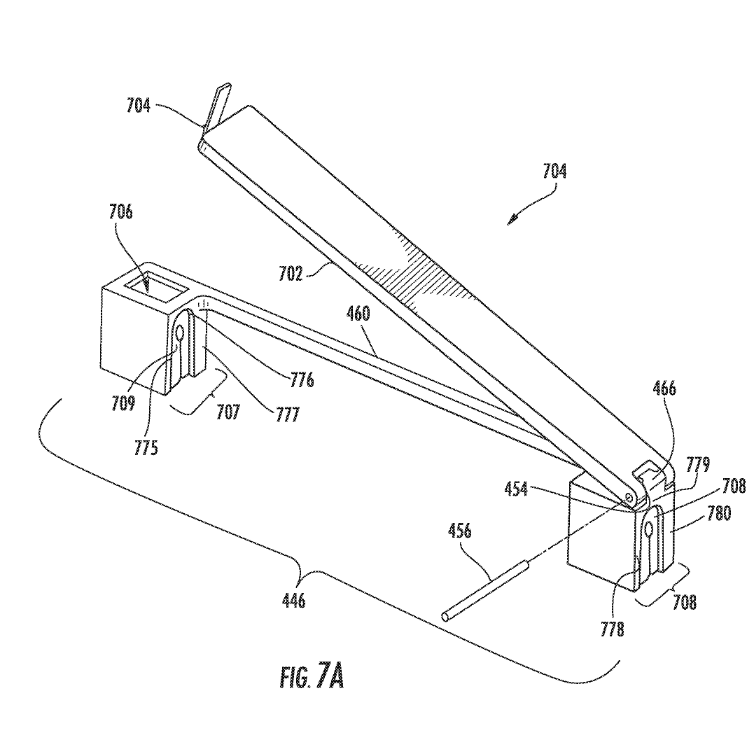

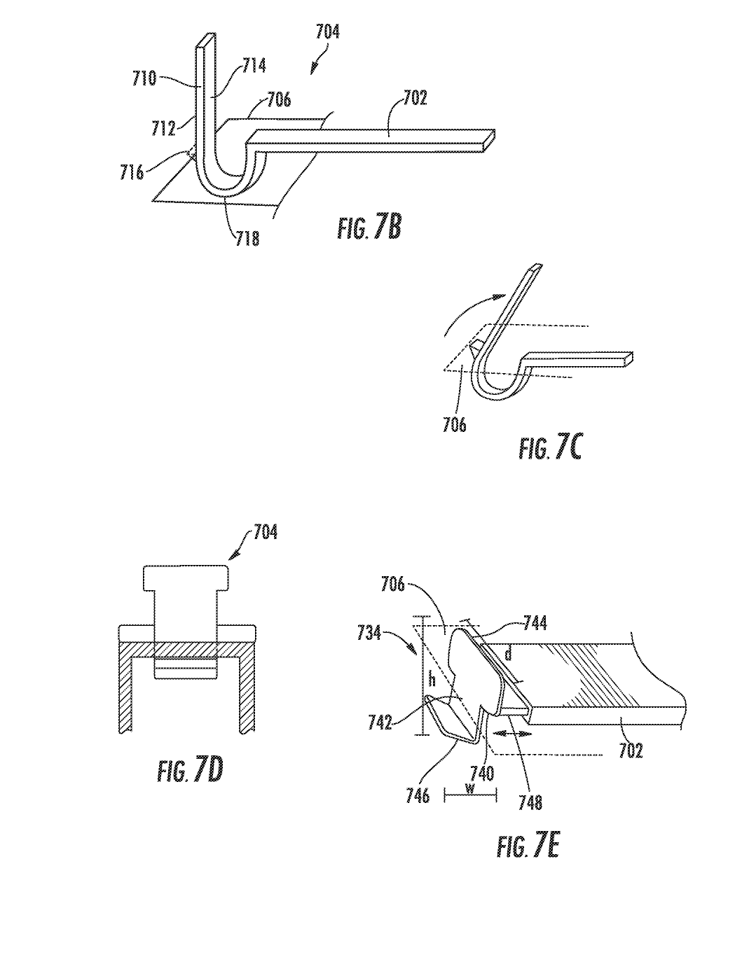

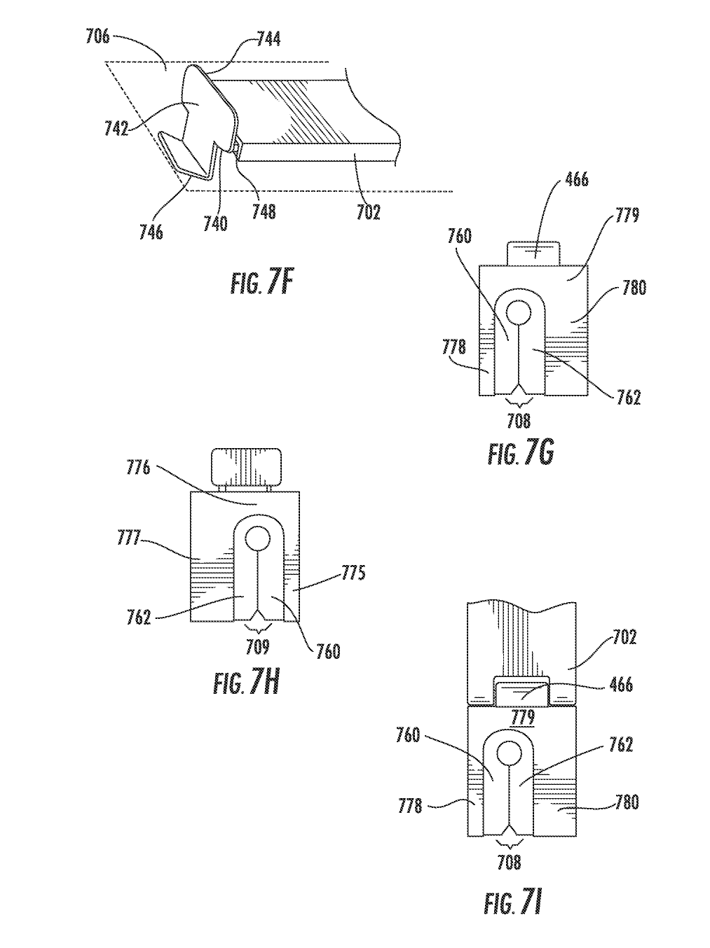

Turning now to FIGS. 7A-7H, various views of an exemplary hanging file retainer with locking mounting clamps for securing the hanging file retainer to a file drawer rail and a snap top retaining member for securing the retaining member closed are shown in accordance with one embodiment of the present invention. FIG. 7A shows a perspective view of hanging file retainer 700 in accordance with one embodiment of the present invention. FIGS. 7B and 7C show perspective views of snap closure 704 of pivoting retainer member 702 in accordance with one embodiment of the present invention. FIG. 7D is a sectional view of snap closure 704 of pivoting retaining member 702 in accordance with one embodiment of the present invention. FIG. 7E is a perspective view of snap closure 734 in a locked position in accordance with one embodiment of the present invention. FIG. 7F is a perspective view of snap closure 734 in an unlocked position in accordance with one embodiment of the present invention. FIG. 7G shows a back end view of hanging file retainer 700 in accordance with one embodiment of the present invention. FIG. 7H shows a front end view of the hanging file retainer 700 in accordance with one embodiment of the present invention. FIG. 7I shows a back end view of the hanging file retainer 700 in an open position in accordance with one embodiment of the present invention. FIGS. 7J and 7K show top and bottom views respectively of hanging file retainer 700 in accordance with one embodiment of the present invention. FIGS. 7L and 7M show side closed and side open views of hanging file retainer 700 in accordance with one embodiment of the present invention.

Hanging file retainer 700 is similar to hanging file retainer 600 except that pivoting retaining member 702 includes a snap closure 704 and hanging file retainer base 446 includes a snap closure receptacle 706 and locking mounting clamps 707, 708. Pivoting retaining member 702 may be secured to locking mounting clamp 708 through insertion of a molded pin 456 into aperture 454. Each locking mounting clamp 707, 708 includes a first vertical clamp member 775 or 778, a second vertical clamp member 777 or 780, and a top clamp member 776 or 779. Locking clamp mounting clamp 707, 708 generally is at a 90 degree angle relative to the file drawer rail. Locking mounting clamps 707, 708 include one or more pieces of foam located on one or more inner surfaces of locking mounting clamps 707, 708, including inner surfaces of first vertical clamp member 775 or 778 and second vertical clamp member 777 or 780. As illustrated in FIG. 7G, locking mounting clamps 707, 708 include two separate pieces of foam, 760, 762 attached to the inner vertical walls of locking mounting clamps 707, 708, respectively. The foam pieces 760, 762 are preferably touching or are closely together, such that when the hanging file retainer 700 is inserted over a file drawer rail, such as for example the file drawer rail shown in FIG. 3, the hanging file retainer 700 will fit snugly onto the rail and will be held securely in place. Each locking mounting clamp 707, 708 is secured to a file drawer rail, such as, for example, file drawer rail 301 depicted in FIG. 3.

Turning now to FIG. 7B, in one embodiment snap closure 704 is of one-piece molded construction connected to pivoting retaining member 702 as shown. Snap closure 704 includes a generally vertical plate 710 having a front surface 712 and a back surface 714, a locking flange 716 attached at a point near the lower end of the front surface 712 of the vertical plate 710, and a connecting flange 718 to connect the vertical plate 710 with the pivoting retaining member 702. Snap closure 704 has a length “l” a width “w” and a height “h.” An example of snap closure 704 dimensions include “l” between about 0.5 and 1.5 inches, “w” between about 0.5 and 1.5 inches, and “h” between about 1 and 3 inches. It is understood that these measurements may very depending on the implementation.

Vertical plate 710, locking flange 716 and connecting flange 718 are preferably of rigid and/or semi-rigid construction. However, at least the portion of the vertical plate 710 located above locking flange 716 is movable in a horizontal direction relative to the connecting flange 718 and generally in a plane parallel to the length of the pivoting retaining member 702. Connecting flange 718 is of semi-rigid construction and serves as a biasing means holding vertical plate 710 in a normal vertical position. Pressure on vertical plate 710 in a direction toward the opposite end of the pivoting retaining member 702 overcomes the force exerted by the connecting flange 718 to cause locking flange 716 to be able to move outside the confines of snap closure 706 releasing pivoting retaining member 702 from the locked position.

For example, when pivoting retaining member 702 is in the closed position, the user may grasp the upper end of vertical plate 710 moving it back toward the opposite end of hanging file retainer 700 which in turn causes locking flange 716 to be drawn slightly upwards as shown in FIG. 7C. This release action enables the user to unlock the hanging file retainer 700 and cause the pivoting retaining member 702 to be pivoted to the open position. When the user desires to move the pivoting retaining member 702 to the closed position, the user manually moves pivoting retaining member 702 to a point just before reaching the snap closure receptacle 706. Downward pressure causes snap closure 704 to be inserted into snap closure receptacle 706, causing locking flange 716 to be initially drawn slightly upwards.

Once the snap action is completed, the top of locking flange 716 resides below the surface of snap closure receptacle 706 as shown in FIG. 7B. Snap closure receptacle 706 is generally slightly shorter in length than the distance “x” between the end of locking flange 716 and the end of pivoting retaining member 702. In one embodiment of the present invention, “x” is about 1.5 inches in length, and snap closure receptacle has a diameter of less than about 1 inch. It is understood that these measurements may vary depending on the implementation. As such, when the top of vertical plate 710 is released, locking flange 716 is returned to its normal position, such that pivoting retaining member 702 is locked in place. Once again, if the user desires to release pivoting retaining member 702, the user may gently pull back the vertical plate 710 while lifting in an upwardly direction the pivoting retaining member 702.

FIG. 7D is a cross-sectional diagram of snap closure 704 shown in the closed and locked position inside snap closure receptacle 706.

Turning now to FIG. 7E, FIG. 7E illustrates an alternative embodiment of snap closure 704. As shown in FIG. 7E, snap closure 734 is shown having a generally vertical plate 740 having a front surface 742 and a back surface 744, a locking flange 746 attached at a point near the lower end of the front surface 742 of the vertical plate 740, and a connecting flange 748 to connect the vertical plate 740 with the pivoting retainer member 702. Snap closure 734 has a length “l” a width “w” and a height “h.” An example of snap closure 734 dimensions include “l” between about 0.5 and 1.5 inches, “w” between about 0.2 and 1 inches, and “h” between about 0.5 and 1.5 inches. Connecting flange 748 is inserted in the body of pivoting retaining member 702. Connecting flange 748 is connected to a spring mechanism or other suitable device (not shown). Connecting flange 748 is of rigid construction and serves as a biasing means holding vertical plate 740 in a normal vertical position and along a horizontal plane at a point in which locking flange 746 is positioned to be confined by snap closure receptacle 706 when pivoting retaining member 702 is in the closed position (FIG. 7E). Pressure on vertical plate 740 in a direction toward the opposite end of the hanging file retainer 700 overcomes the force exerted by the connecting flange 748. This in turn causes vertical plate 740 and locking flange 746 to move horizontally in the direction of the opposite end of hanging file retainer 700 which causes locking flange 746 to be along a horizontal plane that is shorter than the length of snap closure receptacle 706, thus allowing pivoting retaining member 702 to be released from the locked position to the unlocked position (see FIG. 7F).

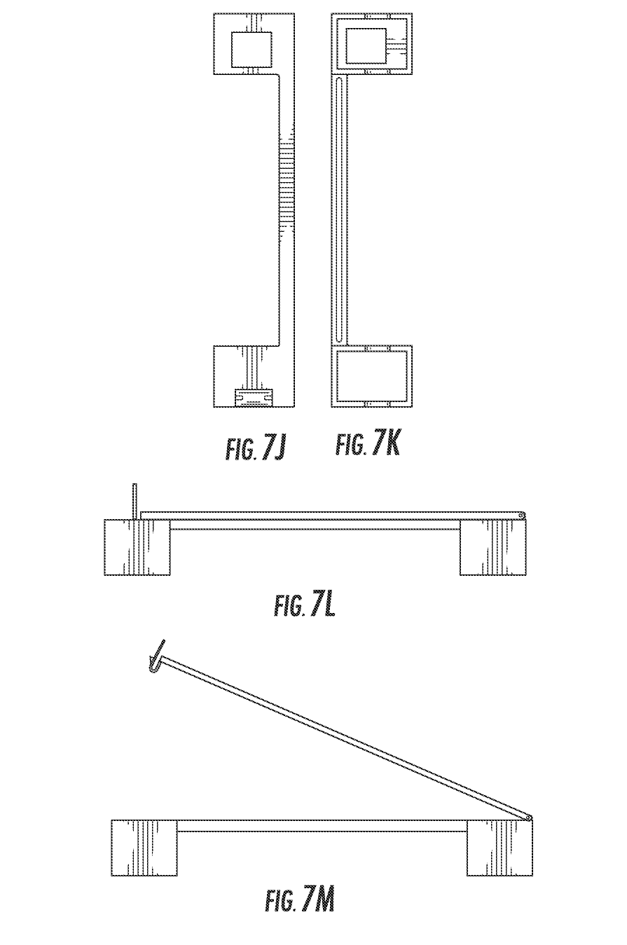

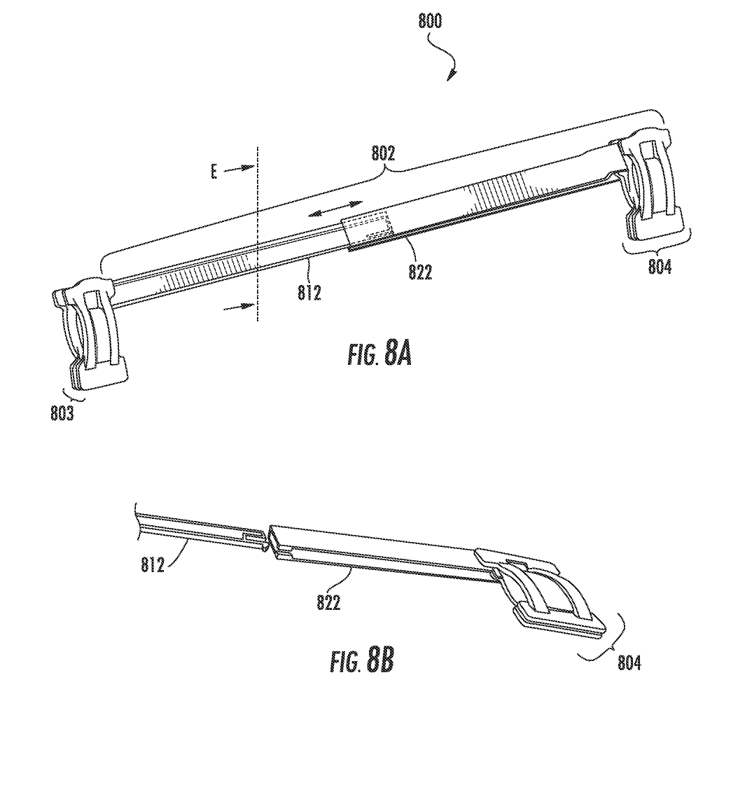

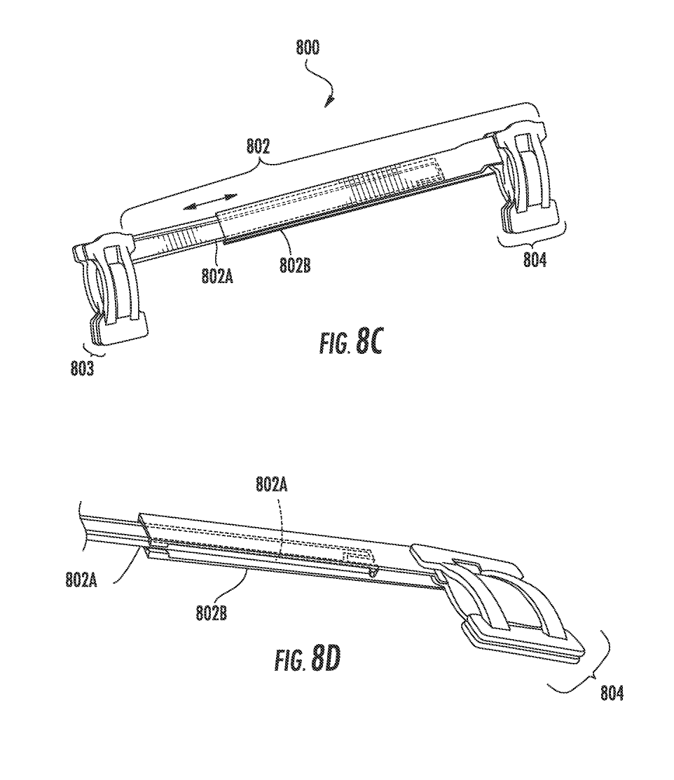

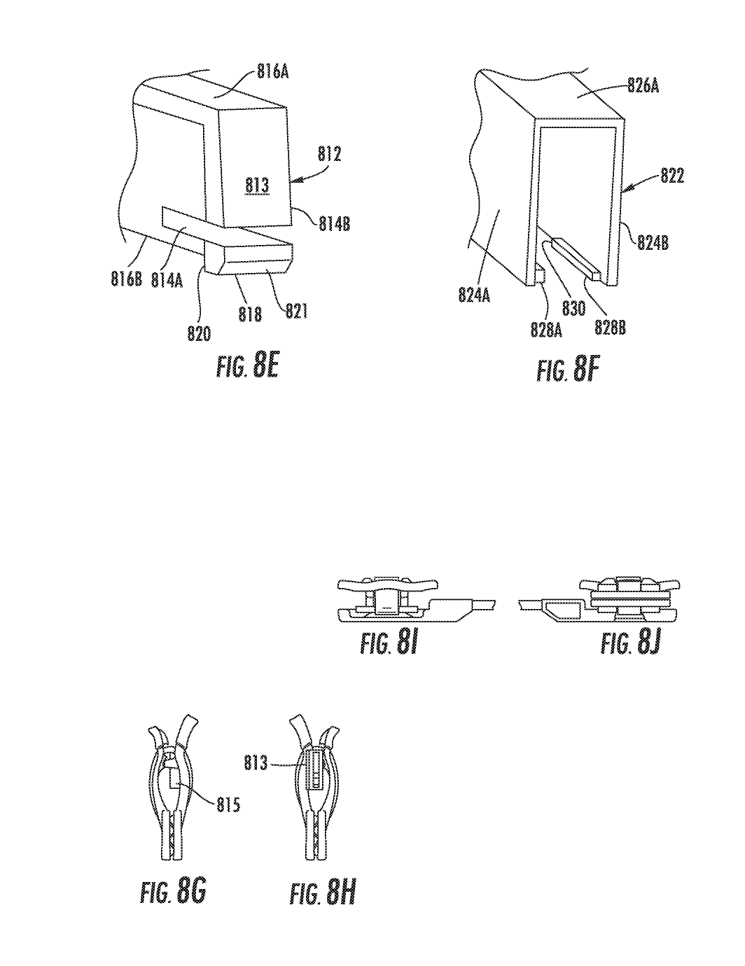

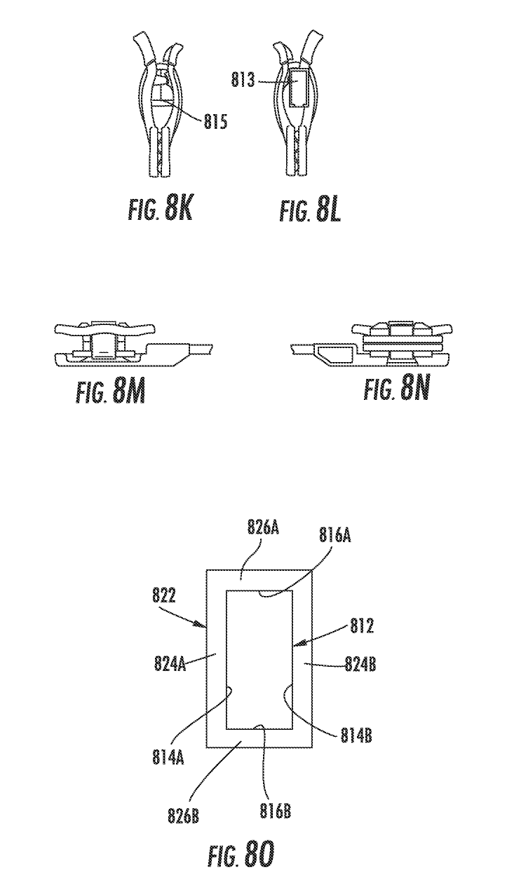

With reference now to FIGS. 8A-O, various views of an exemplary hanging file retainer with mounting clips 803, 804 for securing the hanging file retainer 800 to a file drawer rail and a telescoping retaining member 802 for securing hanging files are shown in accordance with one embodiment of the present invention. FIG. 8A shows a perspective view of hanging file retainer 800 in an extended mode in accordance with one embodiment of the present invention. FIG. 8B shows a bottom perspective view of hanging file retainer 800 in an extended mode in accordance with one embodiment of the present invention. FIG. 8C shows a perspective view of hanging file retainer 800 in an un-extended mode in accordance with one embodiment of the present invention. FIG. 8D shows a bottom perspective view of hanging file retainer 800 in an un-extended mode in accordance with one embodiment of the present invention. FIG. 8E shows an end of linear arm extension 812 of hanging file retainer 800 in accordance with one embodiment of the present invention. FIG. 8F shows an end of extension sleeve 822 of hanging file retainer 800 in accordance with one embodiment of the present invention. FIGS. 8G and 8H show end views of linear extension arm 812 of hanging file retainer 800 in accordance with one embodiment of the present invention. FIGS. 8I and 8J show top and bottom views respectively of linear extension arm 812 of hanging file retainer 800 in accordance with one embodiment of the present invention. FIGS. 8K and 8L show end views of extension sleeve 822 of hanging file retainer 800 in accordance with one embodiment of the present invention. FIGS. 8M and 8N show top and bottom views respectively of extension sleeve 822 in accordance with one embodiment of the present invention. FIG. 8O is a sectional view of hanging file retainer 800 illustrating linear arm extension 812 and extension sleeve 822 in accordance with one embodiment of the present invention.

Hanging file retainer 800 is similar to hanging file retainer 400 except that rather than attaching members 403, 404 first clip 803 and second clip 804 are used. In addition hanging file retainer 800 employs a telescoping retaining member 802 secured to first clip 803 and second clip 804.

In one embodiment, hanging file retainer 800 is a one piece integral molded unit made of a reasonably strong, semi-rigid plastic. In another embodiment, hanging file retainer 800 is a multi-piece construction formed of strong, semi-rigid plastic materials. Any other materials including wood, metal or a composite material may also be used. Hanging file retainer 802 may be of one piece construction or multiple pieces. As shown in FIG. 8A, hanging file retainer 802 is constructed of two pieces, a linear extension arm 812 and an extension sleeve 822. Extension sleeve 822 is slidably mounted to linear extension arm 812 and is moveable between an outward fully extended mode as shown in FIG. 8A and FIG. 8B, and an inward un-extended mode as shown in FIG. 8C and FIG. 8D.

As further shown in FIG. 8E, linear extension arm 812 has opposed side walls 814A and 814B that are connected with opposed top and bottom sides 816A and 816B such that linear extension arm 812 is an elongated rectangle. Linear extension arm 812 also has opposing ends, 813, 815 (see FIGS. 8E, 8G). Opposed sides 814A and 814B are greater in dimension than top and bottom sides 816A and 816B. Operably connected to bottom side 816B is an extended lip or catch 818 used in preventing linear extension arm 812 from being extended out of extension sleeve 822 as further described below. Catch 818 has a back wall 820 and a front wall 821, preferably flush with end 813 of linear extension arm 812. In other embodiments, catch 818 may be located on other parts of linear extension arm 812, for example, instead of (or in addition to) being operably connected to bottom side 816B, catch 818 may be present as a vertical lip or catch, extending out from one or both of opposed side walls 814A and 814B. The vertical lip(s) may be present along the entire vertical distance of opposed side walls 814A and 814B or a portion thereof.

As shown in FIG. 8F, extension sleeve 822 has opposed side walls 824A and 824B and a top wall 826A forming an elongated rectangular compartment within which linear extension arm 812 is slidably mounted. Extension sleeve 822 further has opposed side protrusions 828A and 828B near the lower end of opposed side walls 824A and 824B, respectively, each side protrusion 828A, 828B containing a back stop 830, 832 (not shown). Side protrusions 828A and 828B may be of a greater or lesser length than as shown in FIG. 8F, including a length corresponding to the length of extension sleeve 822. The longer the length of side protrusions 828A, 828B, the shorter the distance linear extension arm 812 will be permitted to extend. Further, side protrusions 828A and 828B may extend further in a horizontal direction to a point in which the two protrusions become a single unit forming a bottom wall in extension sleeve 822. In other embodiments, side protrusions 828A, 828B may be located on other parts of extension sleeve 822, for example, instead of (or in addition to) being near the lower end of opposed side walls 824A and 824B, respectively, side protrusions 828A, 828B may be in a vertical position on the inside wall extending out from one or both of opposed side walls 824A and 824B. The vertical protrusions(s) may be present along the entire vertical distance of opposed side walls 824A and 824B or a portion thereof. The vertical protrusion(s) on the extension sleeve 822 cooperate with complementary vertical protrusions on the linear extension arm 812 (as described above) to prevent linear extension arm 812 from being extended out of extension sleeve 822. Vertical protrusion(s) contained on opposed side walls 824A and 824B of extension sleeve 822 may also be configured such that the portion of opposed side walls 824A and 824B in which a protrusion(s) is attached may be resilient (as compared to other non-resilient portions of opposed side walls 824A and 824B), to permit (if desired) extension of linear extension arm 812 out of extension sleeve 822 and so as to avoid damaging the unit.

Linear extension arm 812 can be moved by being slid relative to extension sleeve 822, such that protrusions 828A and 828B form a “guide” by which bottom side wall 816B of linear extension arm 812 is in contact. In an alternative embodiment, linear grooves or depressions may be formed in sidewalls 814A and 814B of linear extension arm 812. In this embodiment, protrusions 828A and 828B of extension sleeve 822 are confined by the linear grooves so as to form a track or guide during the movement of linear extension arm 812 in and out of extension sleeve 822.

Referring to FIG. 8O, FIG. 8O is an isolated view of the two piece telescoping retaining member 802 showing linear extension arm 812 enveloped within extension sleeve 822. When linear extension arm 812 is fully extended (see FIG. 8A, 8B), linear extension arm 812 is prevented from being extended beyond the outer edges of extension sleeve 822 by the interaction between catch 818 and side protrusions 828A and 828B. In one embodiment of the present invention, when linear extension arm 812 is pulled outwards, at least the portion of the back surface 820 of catch 818 comes in contact with at least a portion of the back surface 830, 832 of one or both of side protrusions 828A, 828B, thus preventing linear extension arm from being extended too far.

Still referring to FIGS. 8A-8D, one or more clips 803, 804 are positioned along the telescoping retaining member 802. In one embodiment of the present invention, telescoping retaining member 802 includes two clips, 803, 804 offset from the center. However, one clip or more than two clips may be utilized. Each of the clips, 803, 804 is constructed in the same manner such that only one of the clips, 803, will be described herein. In one embodiment, the clips may be of the type used in binding paper, sometimes referred to as “binder clips” such as those referenced in U.S. Pat. Nos. 1,139,627 and 1,865,453 incorporated herein by reference. Such clips may be secured to the ends of the telescoping retaining member 802 by attaching (such as by example with screws) the back side of the clip (i.e., the side of the clip that when viewing the clip upright forms a plane parallel with the horizontal and adjoins the two downwardly extending clip “jaws”) to the bottom sides of the linear extension arm 812 and extension sleeve 822, respectively. In this embodiment, the back side of the clip is in contact with a portion of the bottom sides of (and is preferably near the end(s) of) the linear extension arm 812 and extension sleeve 822 respectively, the jaws of the clips residing below the retaining member.

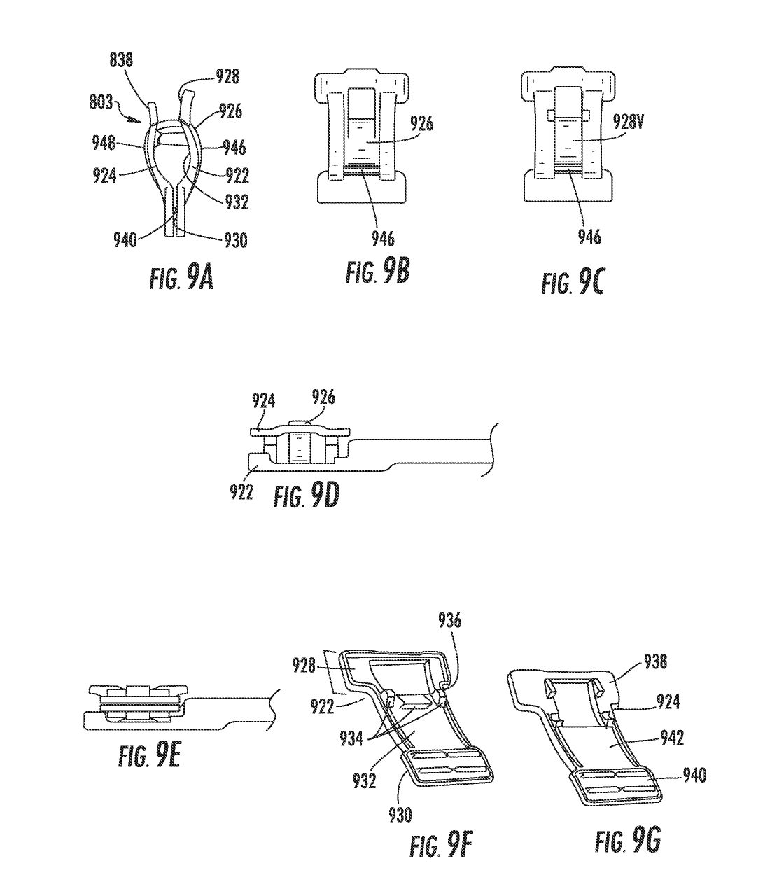

As shown in FIG. 8A, and more particularly in FIG. 9A, clip 803 contains two gripping members, such as jaws, that pivot with respect to each other in order to hold to a file drawer rail, such as file drawer rail 204 as shown in FIG. 2. One gripping member or jaw 922 is stationary or fixed and is made integral with telescoping retaining member 802. The second gripping member or moveable jaw 924 pivots about the fixed jaw 922 to create a functioning clip. A biasing means, such as a elastomeric strip 926, holds jaws 922, 924 together in a normal position to secure hanging file retainer 800 to the hanging file drawer rail. Pressure on jaws 922, 924 overcomes the force of the biasing means to open the clip and release the hanging file retainer 800 from the hanging file drawer rail.

Still referring to FIGS. 9A-9G, fixed jaw 922 contains a top or support face 928 made integral with a linear portion of telescoping member 802. As shown in FIG. 9A, fixed jaw 922 of clip 803 is integral with linear extension arm 812 and fixed jaw 922 of clip 804 is integral with extension sleeve 822. As shown in FIG. 9F, the opposite end of fixed jaw 922 defines a gripping face 930, which will engage the hanging file drawer rail. A transition region 932 between support face 928 and gripping face 930 includes parallel supports 934, which defines a seat 936.

As shown in FIG. 9G, moveable jaw 924 has a top or release face 938 and a gripping face 940 at its other end. In a transition region 942 between the two faces, a grooved member 944 is positioned, such that when the two jaws, 922, 924 are overlaid one on top of the other, grooved member 944 of moveable jaw 924 rests on the seat 936 of the fixed jaw 922. Thus, the jaws 922, 924 pivot about the edge of the parallel support member 934.

As shown in FIGS. 9A-9C, biasing means 926 is preferably made of thermoplastic and is generally a “u” shaped article having distal ends, 946, 948, each of which is attached to opposite outside faces of clip 803 as shown. The two distal ends 946, 948 exert a symmetrical force on fixed jaw 922 and moveable jaw 924 such that the clip 803 is normally in the closed position. Pressure of a user's fingers on the release face 938 of the movable jaw 924 overcomes the force of the biasing means 926 and moves the top or release face 938 near the top or support face 928 of the fixed jaw 922. Due to the pivoting arrangement of the two jaws, this action causes the gripping faces 930, 940 to separate. The user may then attach hanging file retainer 800 to a file drawer rail, such as rail 301 depicted in FIG. 3, by placing the rail between gripping faces 930, 940. When the release face 938 is released by the user, the biasing means 926 moves the jaws 922, 924 back in position and the hanging file retainer 800 is held securely onto the file drawer rail. To release the hanging file retainer from the file drawer rail, the user again applies pressure on the release face 938 of the movable jaw 924 as before, and the hanging file retainer 800 may be removed from the file drawer rail.

Referring in particular to FIGS. 9F and 9G, gripping faces 930, 940 employ molded pads, the surfaces of which improve the gripping action of the gripping faces. Preferably, the pads are made of rubber and include raised portions as shown. However, other suitable materials may be used and exhibit good anti-slip properties.

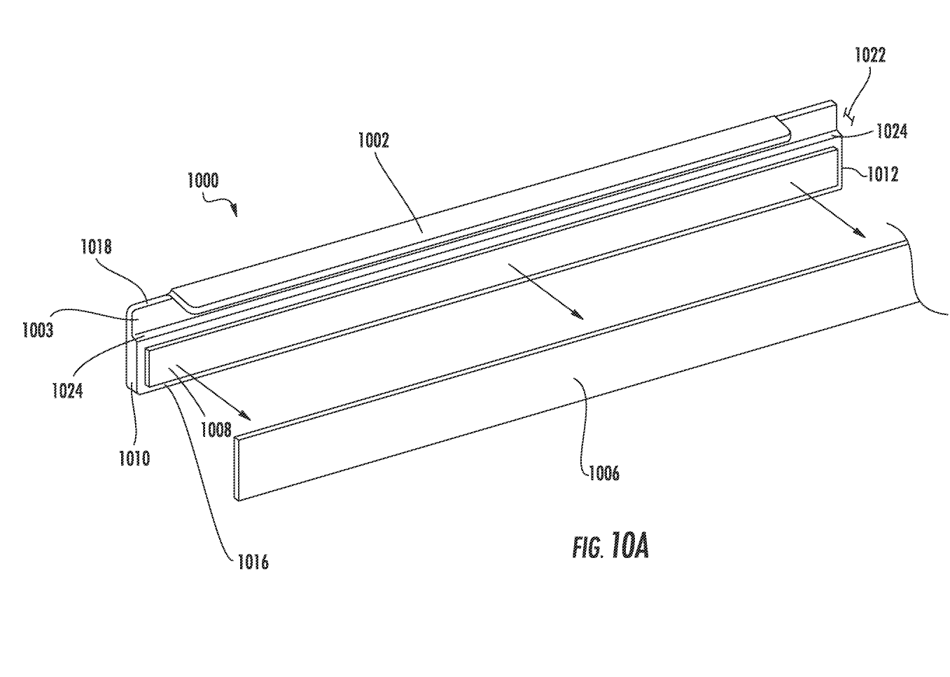

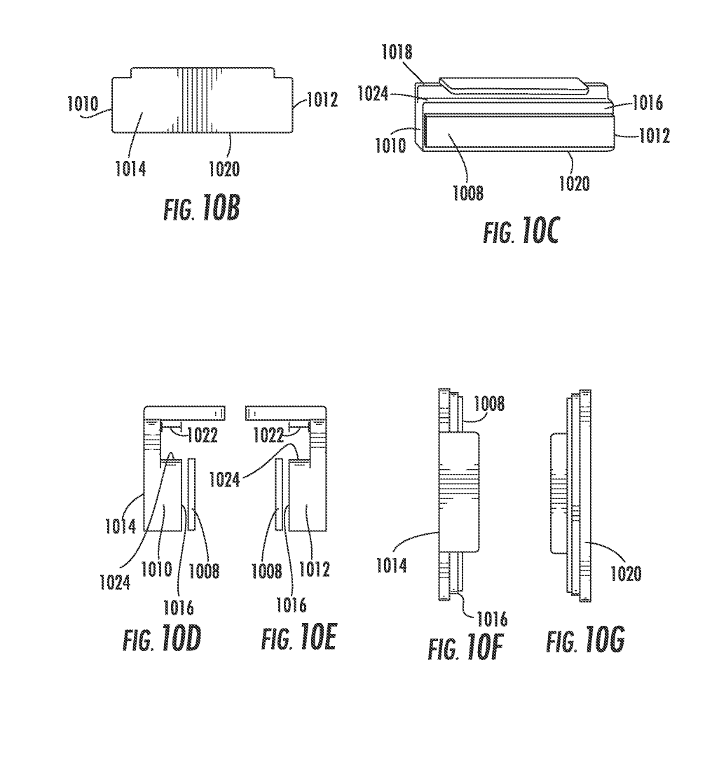

With reference now to FIGS. 10A-10G, various views of an exemplary hanging file retainer 1000 with double stick tape 1008 for securing the hanging file retainer 1000 to a file drawer rail 1006 are shown in accordance with one embodiment of the present invention. FIG. 10A shows a perspective view of hanging file retainer 1000 in accordance with one embodiment of the present invention. FIGS. 10B and 10C show respective front and back side views of hanging file retainer 1000 in accordance with one embodiment of the present invention. FIGS. 10D and 10E show respective front and back end views of hanging file retainer 1000 in accordance with one embodiment of the present invention. FIGS. 10F and 10G show top and bottom views respectively of hanging file retainer 1000 in accordance with one embodiment of the present invention.

Hanging file retainer 1000 is similar to hanging file retainer 400 but does not contain attaching members 403, 404. Hanging file retainer 1000 employs a fixed retaining member 1002 and a horizontal member 1003 which connects the respective ends 1010, 1012 of hanging file retainer 1000 as shown. As shown in FIG. 10A, horizontal member 1003 is affixed to filing drawer rail 1006 by means of double-stick tape 1008 affixed along the attaching face 1016 of horizontal member 1003. In other embodiments, horizontal member 1003 may be secured to the file drawer rail 1006 using screws. As shown particularly in FIGS. 10A and 10B, horizontal member 1003 has a front face 1014 and a attaching face 1016 that are connected with opposed top wall 1018 and bottom wall 1020. Horizontal member 1003 also has opposing ends 1010 and 1012 such that horizontal member 1003 resembles an elongated rectangle. Opposed top and bottom walls 1018 and 1020 are greater in dimension than ends 1010 and 1012.

Along the attaching face 1016, and preferably running the entire length of the attaching face 1016, is an indented portion 1022 having a planar surface 1024 which is parallel to the plane in which retaining member 1002 resides. Planar surface 1024 provides a landing or guide for tabs of a hanging file folder, such as for example, tabs 310 of hanging file folder 308 as shown in FIG. 3. In one embodiment, attaching face 1016 of hanging file retainer 1000 is affixed to a file drawer rail such that planar surface 1024 is parallel to, and substantially in the same plane as, file drawer rail 1006. Preferably, the distance between the file drawer rail 1006 and the attaching face 1016 is of a distance sufficient to allow tabs of hanging file folders, such as for example tabs 310 of hanging file folder 301 as shown in FIG. 3, to move uninhibited along the surface of planar surface 1024.

Typically, the distance between the file drawer rail 1006 and fixed retaining member 1002 is sufficient that movement of the hanger of the hanging file folder back and forth along the file drawer rail 1006 is not significantly impeded, but is less than the distance that the tab extends down over the file drawer rail 1006 so that in no instance may the hanging file folder be removed from or fall off of the file drawer rail 1006.

As shown in FIG. 10A, retaining member 1002 and horizontal member 1003 are integrally formed of a rigid thermoplastic material. In this embodiment, retaining member 1002 provides a housing or covering for the tops of hanging file folder tabs and a sufficient vertical distance is provided between the planar surface 1024 and retaining member 1002 so as to allow sufficient movement of hanging file folders and corresponding tabs along the length of the hanging file retainer, yet sufficient to prevent disengagement of the hanging file folders from the hanging file drawer rail 1006. Preferably, fixed retaining member 1002 is situated sufficiently close to the file drawer rail 1006 such that the hanging file folder may not be raised sufficiently that the tab can move away from the outside part of the file drawer rail 1006. In other embodiments, retaining member 1002 may include a hinge, such that retaining member 1002 is connected to horizontal member 1003 by a hinge (not shown) such that retaining member 1002 may be opened to allow insertion of hanging file folders and then subsequently closed over the file rail to secure the hanging file folders.

Although described throughout primarily with reference to hanging file retainers in which the attaching members are located at the extreme ends of a retaining member, the present invention is not limited to such embodiments. In some embodiments, the retaining member may extend past one or both attaching members such that one or both attaching members are not at an extreme end of the retaining member. Furthermore, although described primarily with reference to hanging file retainers having two attaching members, the present invention is not limited to such and may include only a single attaching member or three or more attaching members.

In embodiments in which metal and magnets are used as a fastener, the metal may be replaced with a complimentary magnet configured such that the complementary pair of magnets are attracted to each other. It should also be noted that the retaining members in the various embodiments described above are typically at least long enough to span the distance between the first and second attaching members, but in some other embodiments, the retaining member may be longer such that the retaining member extends past one or both attaching members. Furthermore, although described primarily with reference to embodiments in which two attaching members are utilized, the present invention is not limited to such. Those skilled in the art will recognize that other numbers of attaching members are possible in other embodiments.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A hanging file folder retainer, comprising:
a first attaching member for coupling to a hanging file drawer rail;
a second attaching member for coupling to the hanging file drawer rail wherein the second attaching member is linearly disposed from said first attaching member;
a retaining member functionally coupled to said first and second attaching member, wherein the length of said retaining member can be increased or decreased upon installation along the hanging file drawer rail depending on the length of the hanging file drawer rail, and wherein in at least one functional position, said retaining member inhibits hanging file tabs from disengaging from the hanging file drawer rail.

2. The hanging file folder retainer as recited in claim 1, wherein the first attaching member clips onto the hanging file drawer rail.

3. The hanging file folder retainer as recited in claim 1, wherein the first attaching member and the second attaching member clip on to the hanging file drawer rail.

4. The hanging file folder retainer as recited in claim 1, wherein the first attaching member, the second attaching member, and the retaining member comprise a semi-rigid material.

5. The hanging file folder retainer as recited in claim 1, wherein at least one of the first attaching member, the second attaching member, and the retaining member comprise a semi-rigid material.

6. The hanging file folder retainer as recited in claim 4, wherein the semi-rigid material comprises a thermoplastic.

7. The hanging file folder retainer as recited in claim 1, wherein the first attaching member comprises a thumb screw for affixing the first attaching member to the hanging file drawer rail.

8. The hanging file folder retainer as recited in claim 1, wherein the retaining member is configured to pivot about an axis between at least a closed position and an open position wherein the hanging file folder tabs are inhibited from disengaging from the hanging file drawer rail when the retaining member is in the closed position and wherein hanging file folders may be removed from the hanging file drawer when the retaining member is in the open position.

9. The hanging file folder retainer as recited in claim 8, wherein the retaining member pivots about a pivot axis that is substantially perpendicular to a line defined by the first and second attaching members.

10. The hanging file folder retainer as recited in claim 8, wherein the retaining member pivots about a pivot axis that is substantially parallel to a line defined by the first and second attaching members.

11. The hanging file folder retainer as recited in claim 1, further comprising at least two pivot axes by which the retaining member may be configured to pivot between at least a closed position and an open position, and wherein the direction of the retaining member may be interchanged between the at least two pivot axes.

12. The hanging file folder retainer as recited in claim 1, wherein the retaining member comprises a first and a second end wherein at least one of the first and second ends comprises a snap lock for functionally attaching the retaining member to one of the first and second attaching members.

13. The hanging file folder retainer as recited in claim 1, wherein said retaining member comprises one of a removable member and a pivoting member, further comprising:
at least one securing member for securing said retaining member in a closed position.

14. The hanging file folder retainer as recited in claim 13, wherein the securing member comprises at least one of a screw, a molded pin lock, a hook and loop fastener, and a magnet.

15. A hanging file folder retainer, comprising:
attaching means for securing at least a part of the hanging file folder retainer to a hanging file drawer rail;
retaining means functionally coupled to said attaching means and configurable for at least an open and a closed position, wherein when configured in said closed position said retaining means inhibit dislodging of a hanging file folder from the hanging file drawer rail.

16. The hanging file folder retainer as recited in claim 15, further comprising:
hinging means for functionally coupling the retaining means to the attaching means wherein the retaining means is configured to pivot between at least a closed position and an open position about said hinging means.

17. The hanging file folder retainer as recited in claim 15, further comprising:
securing means for securing said retaining means in a closed position.

18. The hanging file folder retainer as recited in claim 17, wherein the securing means comprise a molded pin lock.

19. The hanging file folder retainer as recited in claim 17, wherein the securing means comprise a magnet.

20. The hanging file folder retainer as recited in claim 16, wherein the hinging means comprise one or more clips attached to the attaching means, and a bar member integrally connected to the retaining means and cooperating with the one or more clips.

21. The hanging file folder retainer as recited in claim 15, wherein the hinging means comprises multiple hinging means by which the retaining means is configured to pivot between at least a closed position and an open position about each said respective multiple hinging means.

22. The hanging file folder retainer as recited in claim 15, wherein the attaching means comprise a clip.

23. The hanging file folder retainer as recited in claim 14, wherein said retaining means is integrally formed with said attaching means.

21. A hanging file folder retainer, comprising:
attaching means for securing at least a part of the hanging file folder retainer to a hanging file drawer rail;
retaining means functionally coupled to said attaching means and configurable for only a closed position, wherein said retaining means inhibit dislodging of a hanging file folder from the hanging file drawer rail.

22. The hanging file folder retainer as recited in claim 21, wherein the attaching means comprise at least one of adhesive means, mechanical means, and electromagnetic means.

23. The hanging file folder retainer as recited in claim 21, wherein said retaining means is non-removable from said attaching means.

24. The hanging file folder retainer as recited in claim 14, wherein said attaching means comprise adhesive means.
